(19) United States
(12) Patent Application Publication
(10) Pub. No.: US 2026/0053690 A1
(43) Pub. Date: Feb. 26, 2026

(54) HAND TRAINING APPARATUS

(71) Applicant: P & S MECHANICS CO., LTD., Seoul (KR)

(72) Inventors: Kwang Hun PARK, Seoul (KR); Jong Hyeok KIM, Siheung-si, Gyeonggi-Do (KR); Kyung Hwan LEE, Anyang-si, Gyeonggi-do (KR)

(21) Appl. No.: 18/880,551

(22) PCT Filed: Sep. 14, 2022
(86) PCT No.: PCT/KR2022/013718

§ 371 Date: Nov. 7, 2025

(30) Foreign Application Priority Data
Jul. 4, 2022 (KR) 10-2022-0081802

(51) Int. Cl. A61H 1/02

(52) U.S. Cl. CPC A61H 1/0288; A61H 2201/0153; A61H 2201/1215; A61H 2201/1635; A61H 2201/1664

(57) ABSTRACT

The present inventive concept relates to an exercise device for hand rehabilitation and, more particularly, to an exercise device for hand rehabilitation effectively providing extension motion and radioulnar motion for hand joints.

The exercise device for hand rehabilitation according to an embodiment of the present inventive concept includes a wrist support part worn on a wrist of a trainee, a plurality of finger-wearing parts worn on fingers of the trainee, a plurality of wires respectively connected to the plurality of finger-wearing parts, and a driving part configured to provide driving force by pulling or releasing the plurality of wires to move the plurality of finger-wearing parts.

### TECHNICAL FIELD

The present inventive concept relates to an exercise device for hand rehabilitation and, more particularly, to an exercise device for hand rehabilitation effectively providing extension motion and radioulnar motion for hand joints.

### BACKGROUND ART

In general, an exercise device for hand rehabilitation is a device that helps rehabilitation exercises for trainees who have hand paralysis symptoms or abnormalities in hand joints or hand muscle strength and endurance.

Most trainees with hand discomfort have difficulty moving their hands on their own, and thus, the trainees performed hand exercises by wearing the exercise device for hand rehabilitation and moving their hands following movement patterns induced by the exercise device for the hand rehabilitation. These exercise devices for the hand rehabilitations have motion trajectories due to their unique structure. Conventional exercise device for hand rehabilitation provides motion trajectory for extension motion by applying force to the fingers to straighten curled, twisted, or stiffened hands. However, according to the degree of hand stiffness, some finger joints may fail to extend fully.

To solve the problem, additional joints have been incorporated into the existing devices for hand rehabilitation. As a result, there are problems such as the structure of the exercise device for hand rehabilitation becoming more complex, and the weight of the device increasing, making it difficult for trainees to wear. Moreover, the device fails to provide sufficient ranges of extension or radioulnar motion.
(Patent Document 1) Korean Patent Publication No. 10-2018-0038113

### DISCLOSURE OF THE INVENTIVE CONCEPT

### Technical Problem

The present inventive concept relates to an exercise device for hand rehabilitation, featuring a compact and lightweight structure capable of providing a motion trajectory of extension or radioulnar motion for a hand joint.

### Technical Solution

An exercise device for hand rehabilitation according to an embodiment of the present inventive concept may include a wrist support part worn on a wrist of a trainee; a plurality of finger-wearing parts worn on fingers of the trainee; a plurality of wires respectively connected to the plurality of finger-wearing parts; and a driving part configured to provide driving force by pulling or releasing the plurality of wires to move the plurality of finger-wearing parts.

The driving part may be fixed to the wrist support part.

Each of the plurality of finger-wearing parts may include: a finger fixation pad worn on a distal segment of the trainee's finger; a connection member to which the finger fixation pad is connected and fixed; and a wire path guide fixed to the connection member to guide a movement path of the wire.

The wire path guide may include: a first wire path guide, which is fixed to the connection member to extend outward from the connection member and is configured to guide the movement path of the wire, and a second wire path guide, which is spaced apart from the first wire path guide and fixed to the connection member to extend outward and is configured to guide the movement path of the wire.

The first wire path guide may have a length extending outward longer than that of the second wire path guide.

The connection member may have a shape extending in one direction, the first wire guide may be fixed to one end of the connection member corresponding to a position to which the finger fixation pad is connected, and the second wire path guide may be fixed to the other end of the connection member spaced apart in one direction from the one end of the connection member.

The connection member may include a wire fixation part to which wires, which are respectively connected to the plurality of finger-wearing parts, are fixed, and the wire fixation part may be provided between a position at which the first wire path guide is fixed to the connection member and a position at which the second wire path guide is fixed to the connection member.

Each of the plurality of finger-wearing parts may further include a wire length adjustment part configured to adjust a length of the wire according to a length of the trainee's finger.

The plurality of wires may be made of an elastic material.

The wrist support part may include: a hand dorsum support part worn on a trainee's hand dorsum; a forearm support part worn on a trainee's forearm; and a connection support part to which the hand dorsum support part and the forearm support part are rotatably connected.

The hand dorsum support part and the connection support part may be rotatably connected to each other in a flexion-extension direction, and the forearm support part and the connection support part may be rotatably connected to each other in a radioulnar direction.

The connection support part may include a motion-limiting part configured to limit a flexion-extension angle or a radioulnar angle.

The wrist support part may further include a wire guide part fixed to at least one of the hand dorsum support part or the connection support part to guide the movement of the wires.

The exercise device may further include a wire connection part to which the plurality of wires are connected, wherein the driving part may include: a motor part configured to move the wire connection part; and a control part configured to provide a driving signal to the motor part.

The exercise device may further include a senor configured to measure an electrical signal generated in nerves or muscles of the trainee's wrist, wherein the control part may generate the driving signal based on a measurement signal from the sensor part.

The exercise device may further include an exercise condition setting part configured to set at least one hand exercise condition among a motion trajectory, a motion speed, a motion acceleration, a motion position, a motion direction, a motion range, a motion angle, a motion intensity, or the trainee's exercising pattern, wherein the control part may generate the driving signal according to the exercise condition set by the exercise condition setting part.

### Advantageous Effects

According to the exercise device for hand rehabilitation of an embodiment of the present inventive concept, by pulling or releasing the plurality of wires, each connected to the plurality of finger-wearing parts, the exercise device for hand rehabilitation may assist the movement of the trainee's hand joints without requiring additional joint parts or connection structures corresponding to the hand joints. This enables the provision of various and natural motion trajectories that align with the motion of the hand joints, allowing the trainee to safely and comfortably perform hand joint rehabilitation exercise without experiencing discomfort.

Also, the position of the finger fixation pads worn on the distal segments of the trainee's fingers may be adjusted to enable the trainee to wear the exercise device for hand rehabilitation and perform hand exercise regardless of the length of their fingers. Accordingly, the lengths of the wires respectively connected to the plurality of finger-wearing parts may be adjusted, sequential extension motion of the distal interphalangeal joints, the proximal interphalangeal joints, and the metacarpophalangeal joints of the index, middle, ring, and little fingers, as well as the interphalangeal joint, metacarpophalangeal joint of the thumb, among the five fingers, and the wrist joint, may be provided to all hand trainees.

Furthermore, it is possible to enable sequential extension motion of individual finger joints while simultaneously moving the wires toward the distal segments of the trainee's fingers.

In addition, the hand dorsum support part may be rotatably connected in the flexion-extension direction, and the forearm support part may be rotatably connected to the connection support part in the radioulnar direction, allowing the hand trainee to perform not only extension motion of the hand joints but also radioulnar motion of the hand joints, enabling more effective hand rehabilitation exercise.

Additionally, since the hand exercise is performed based on electrical signals generated in the nerves or muscles of the trainee's wrist or according to preset hand exercise conditions, discomfort experienced by the hand trainee may be alleviated, and the scope of hand exercise without feeling discomfort may be expanded.

### BRIEF DESCRIPTION OF THE DRAWINGS

FIG. 1 is a schematic perspective view of an exercise device for hand rehabilitation according to an embodiment of the present inventive concept.

FIG. 2 is a schematic perspective view illustrating a finger wearing part according to an embodiment of the present inventive concept.

FIG. 3 is a view illustrating an extension motion mode of the exercise device for hand rehabilitation according to an embodiment of the present inventive concept.

FIG. 4 is a view illustrating a radioulnar motion mode of the exercise device for hand rehabilitation according to an embodiment of the present inventive concept.

FIG. 5 is a view illustrating a configuration of a driving part of the exercise device for hand rehabilitation according to an embodiment of the present inventive concept.

### MODE FOR CARRYING OUT THE INVENTIVE CONCEPT

Hereinafter, specific embodiments will be described in more detail with reference to the accompanying drawings. The present inventive concept may, however, be embodied in different forms and should not be construed as limited to the embodiments set forth herein. Rather, these embodiments are provided so that this disclosure will be thorough and complete, and will fully convey the scope of the present inventive concept to those skilled in the art. In the descriptions, the same elements are denoted with the same reference numerals. In the figures, the dimensions of layers and regions are exaggerated for clarity of illustration. Like reference numerals refer to like elements throughout.

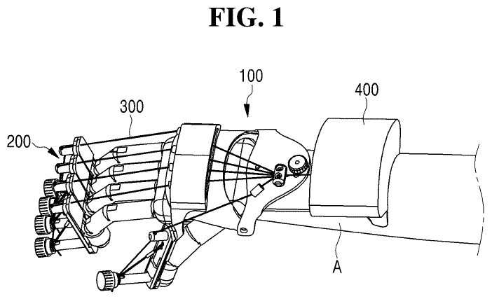

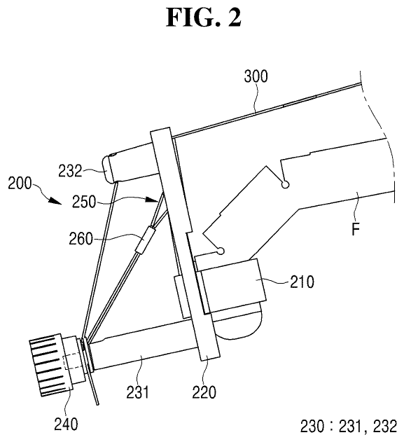

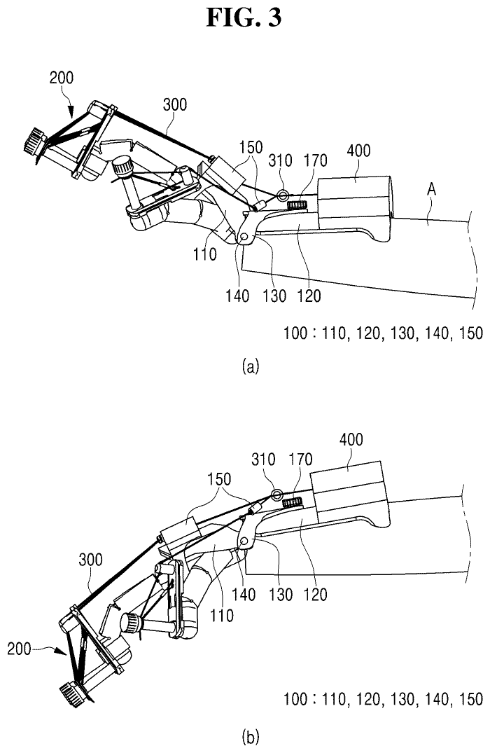

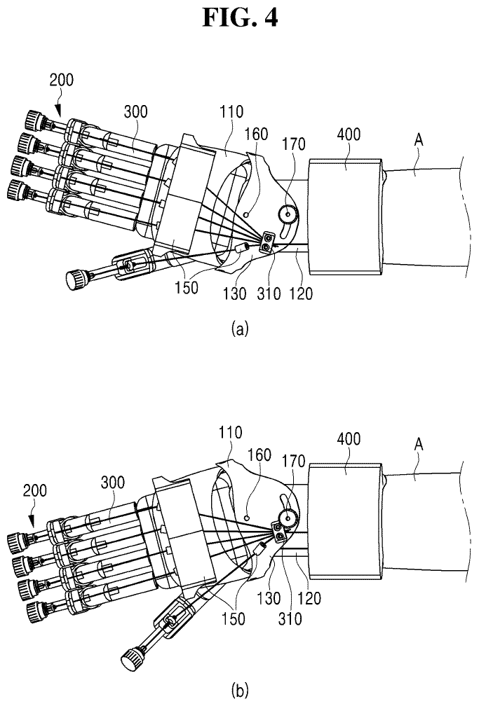

FIG. 1 is a schematic perspective view of an exercise device for hand rehabilitation according to an embodiment of the present inventive concept, and FIG. 2 is a schematic perspective view illustrating a finger wearing part according to an embodiment of the present inventive concept. FIG. 3 is a view illustrating an extension motion mode of the exercise device for hand rehabilitation according to an embodiment of the present inventive concept, and FIG. 4 is a view illustrating a radioulnar motion mode of the exercise device for hand rehabilitation according to an embodiment of the present inventive concept.

Referring to FIGS. 1 to 4, an exercise device for hand rehabilitation according to an embodiment of the present inventive concept may include: a wrist support part 100 worn on a wrist of a trainee; a plurality of finger-wearing parts 200 worn on fingers of the trainee; a plurality of wires 300, respectively connected to the plurality of finger-wearing parts 200; and a driving part 400 that provides driving force by pulling or releasing the plurality of wires 300 to move the plurality of finger-wearing parts 200.

The wrist support part 100 serves as a main frame part, worn on a wrist A of a hand rehabilitation trainee (hereinafter, referred to as a “hand trainee”) to support the exercise device for hand rehabilitation. Rather than fixing the finger-wearing parts 200, which are necessary for motion of finger joints, or the wires 300, which transmit driving force, to a separate structure, it is more effective for the hand trainee to perform exercise while wearing the exercise device for hand rehabilitation. This allows for free and unrestricted movements during hand exercise. The wrist support part 100 supports the exercise device for hand rehabilitation while being worn on the wrist of the hand trainee, and also serves to endure reactive force exerted on the finger-wearing parts when the plurality of wires are pulled or released to move the finger-wearing parts during hand exercise, thereby guiding finger flexion, extension, and radioulnar movements.

Each of the plurality of finger-wearing parts 200 may be worn on a finger of the hand trainee, allowing a target position on the finger (e.g., a fingertip segment) where force is applied for the motion of finger joint to be specified.

The plurality of wires 300 may be respectively connected to the plurality of finger-wearing parts 200 and transmit the force required for the motion of finger joints. To ensure smooth extension motion of the finger joints, the plurality of wires 300 may extend from a hand dorsum or fingers and be connected to the finger-wearing parts 200, providing pulling force in a direction of the back of the fingers. Since the hand trainee requires motion trajectories to straighten curled, twisted, or stiffened hands, the wire, which has a simple structure, may be used to provide supplementary force, helping fully extend the finger segments.

The driving part 400 may provide driving force, which allows the plurality of wires 300 to be pulled or released according to the motion trajectories required for hand rehabilitation exercises, to move the plurality of finger-wearing parts 200.

The driving part 400 may be fixed to the wrist support part 100, allowing the hand trainee to perform exercises while wearing the exercise device for hand rehabilitation. Since the driving part 400 fixed to the wrist support part 100 pulls or releases the plurality of wires 300, the hand trainee may freely perform desired exercises while wearing the exercise device for hand rehabilitation.

Each of the plurality of finger-wearing parts 200 may include a finger fixation pad 210 worn on a fingertip of the trainee's finger; a connection member 220 to which the finger fixation pad 210 is connected and fixed; and a wire path guide 230 fixed to the connection member 220 to guide a movement path of the wire.

The finger fixation pad 210 may be worn on a finger F distal segment of the trainee, determining the position to which force is transmitted for finger joint motion. Since the finger including finger joints have motion trajectories determined by their unique structures, when force transmitted to the finger distal segment via each of the wires 300 pulls the finger toward the back of the finger, sequential extension motion from a distal joint to a proximal joint may be performed.

The finger fixation pad 210 may be connected and fixed to the connection member 220, and the connection member 220 may be connected to the wire 300 and moved by the wire 300.

The wire path guide 230 may guide the movement path of the wire 300 while being fixed to the connection member 220. Since the force for finger joint motion must be transmitted to the finger distal segment in a manner that pulls it toward the back of the finger to enable sequential extension motion from the distal joint to the proximal joint, the force transmission path (i.e., the movement path of the wire) needs to be guided to be positioned at the side of the back of the finger. As with pulling the wire 300, when releasing the wire 300 for finger joint flexion motion, the force transmission path (i.e., the movement path of the wire) must also be guided to be positioned on the back of the finger. If the wire path guide 230 is not present, when the trainee performs finger joint exercises, the movement of the finger according to the direction of the finger joint motion may cause the wire's movement path to deviate from passing along the back of the finger. In such cases, not only does sequential extension motion from the distal joint to the proximal joint may become difficult, but an extension direction of the finger joint may also become misaligned, causing pain and injury to the hand trainee's finger.

When the wire 300 guided by the wire path guide 230 pulls the finger fixation pad 210, which is worn on the finger distal segment, toward the back of the finger, it may firstly extend a first finger joint. When the first finger joint is fully extended within its possible range, additional pulling force by the wire 300 may allow a second finger joint to be extended, enabling the hand trainee to perform sequential extension motion of the finger joints.

The wire path guide 230 may include a first wire path guide 231, which is fixed to the connection member 220 and extends outward from the connection member 220 to guide the movement path of the wire 300, and a second wire path guide 232, which is spaced apart from the first wire path guide 231 and is also fixed to the connection member 220 to extend outward and guide the movement path of the wire 300.

To enable sequential extension motion from the distal joint to the proximal joint, the force for finger joint motion must be transmitted to the finger distal segment in a manner that pulls the finger toward the back of the finger. For this purpose, the extension direction or movement path of the wire 300 may be parallel to an extension direction of the finger F. Here, “parallel” does not necessarily mean physically perfectly parallel but may include angles within an acceptable range of ±10°.

On the other hand, when the wire path guide 230 guides the wire path at only one point, the wire 300 may bend around the wire path guide 230. To address this, the wire 300 may be guided at two points using the first wire path guide 231 and the second wire path guide 232, which are spaced apart from each other, allowing the wire 300 to remain straight.

To prevent the wire 300 from interfering with other components such as the connection member 220, the first wire path guide 231 and the second wire path guide 232 may extend outward from one surface of the connection member 220. Furthermore, a spacing direction of the first wire path guide 231 and the second wire path guide 232 may be parallel to the extension direction of the finger F, ensuring that the movement path of the wire 300 aligns with a finger's extension direction. Since the connection member 220 is provided for each finger, the connection member 220 may have a shape that extends in one direction to avoid interference with another connection member provided for an adjacent finger. Additionally, the connection member 220 may have a plate shape to ensure both lightness and stability in fixing the wire path guide 230 and the finger fixation pad 210. The wire path guide 230 may be fixed to the one surface of the connection member 220, and the finger fixation pad 210 may be fixed to the other surface of the connection member 220.

The finger-wearing part 200 may be worn on the finger distal segment of the trainee such that an extended direction of the connection member 220 aligns parallel to the finger's extension direction. Here, the first wire path guide 231 may be fixed to one end of the connection member 220 corresponding to a position where the finger fixation pad 210 is connected, and the second wire path guide 232 may be fixed to the other end of the connection member 220, spaced apart from the one end of the connection member in the one direction. Accordingly, the movement path of the wire 300 may be parallel to the extension direction of the finger.

The first wire path guide 231 may have a length (or height) that extends outward greater than that of the second wire path guide 232.

Meanwhile, the connection member 220 may include a wire fixing part 250 to which the wire connected to each of the plurality of finger-wearing parts is fixed. The wire fixing part 250 may be provided between a position where the first wire path guide 231 is fixed to the connection member 220 and a position where the second wire path guide 232 is fixed to the connection member 220. The wire fixing part 250 may be provided to be movable along the extension direction of the connection member 220 so as to change the fixing position of the wire, alternatively, a plurality of wire fixing parts 250 may be provided.

The first wire path guide 231 and the second wire path guide 232 may each have an outer end to which the wire is movably connected to guide the path of the wire 300. The movement size, angle, and range of the connected wire 300 may be determined based on relative positions of the first wire path guide 231, the second wire path guide 232, and the wire fixing part 250. Since the extension length of the first wire path guide 231, fixed to one end of the connection member 220 corresponding to the position where the finger fixation pad 210 is connected, is longer than that of the second wire path guide 232, fixed to the other end of the connection member 220, and the wire fixing part 250, where the wire passing through the first wire path guide 231 is fixed, is positioned between the first and second wire path guides 231 and 232, sequential extension of the finger joints may be enabled to correspond to the unique motion trajectories, where the rotation angle and size of the finger joints increase progressively from the proximal part to the distal part of the finger.

Each of the plurality of finger-wearing parts 200 may further include a wire length adjustment part 240 to adjust a length of the wire 300 according to a length of the trainee's finger F.

Since the finger extension motion is performed by the finger fixation pad 210 worn on the finger distal segment and the pulling and releasing of the wire connected to the finger fixation pad 210, it is necessary for the driving force to be transmitted to the finger fixation pad 210 promptly and precisely to enable proper extension-flexion motion. For this purpose, the wire 300 connecting the driving part 400 and the finger fixation pad 210 must be kept taut without slack.

Hand trainees have individually different finger lengths, and the five fingers of a single hand also vary in length.

Therefore, in the present inventive concept, the wire length adjustment parts 240 may be utilized to individually adjust the lengths of the wires 300, which connect the driving part 400 to the finger fixation pads 210, according to the length of each finger, ensuring the wires remain taut. The wire length adjustment part 240 may adjust the wire length by controlling the degree or number of turns of the wire wound using an adjustment lever or by adjusting the length using a fixing slot 260, but, it is not particularly limited to thereto Meanwhile, by adjusting the wire length, extension motion of five fingers having varying lengths may be simultaneously performed due to the driving force provided by the driving part 400. In other words, for the extension motion of five fingers having different lengths and ranges of motion, five separate motor parts would typically be required to individually move the wires corresponding to each finger. However, since the wire length adjustment parts 240 adjust the length of the wire to keep the wire taut, the extension motion of fingers having different lengths may be achieved using a single motor part to provide the driving force. Thus, as the exercise device for hand rehabilitation with a simple structure, sequential extension motion of distal interphalangeal joints (first finger joints), proximal interphalangeal joints (second finger joints), and metacarpophalangeal joints (third finger joints) of the index, middle, ring, and little fingers, as well as an interphalangeal joint (a first thumb joint) and a metacarpophalangeal joint (a second thumb joint) of a thumb, and a wrist joint, may be applied to all hand trainees regardless of their finger lengths.

The plurality of wires 300 may be made of an elastic material.

Movement distances of the wires required for maximum extension may vary due to differences in the lengths and ranges of motion of the trainee's fingers. If the wire 300 is made of the elastic material, displacement caused by differences in finger lengths and ranges of motion may be compensated for by the length changes resulting from the elasticity of the wires, allowing all fingers to reach maximum extension regardless of their individual movement distances or ranges of motion.

Meanwhile, the plurality of finger-wearing parts 200 may be connected to the wrist support part 100 solely by the plurality of wires 300, so that the finger movements of the hand trainee having unnatural finger motion are not hindered by the exercise device for hand rehabilitation during hand exercise after wearing the device. Alternatively, so as to make it convenient for the hand trainee to wear the exercise device for hand rehabilitation, the wrist support part 100 and the finger-wearing parts 200 may be connected to each other by separate flexible and thin fibers or similar materials within a range that does not interfere with hand exercising movements.

The exercise device for hand rehabilitation needs to enable the hand trainee to perform the wrist joint extension motion and radioulnar motion along with the finger joint extension motion. For the wrist joint extension motion and radioulnar motion, the wrist support part 100 must be capable of rotating in an extension-flexion direction and a radioulnar direction. Accordingly, the wrist support part 100 may include a hand dorsum support part 110 worn on the trainee's hand dorsum; a forearm support part 120 worn on the trainee's forearm; and a connection support part 130 to which the hand dorsum support part 110 and the forearm support part 120 are rotatably connected. Through this structure, the wrist support part 100 may guide the wrist joint movement in the radial and ulnar directions, as well as flexion and extension movements, enabling safe wrist joint exercise.

The wrist support part 100 may include the hand dorsum support part 110 worn on the trainee's hand dorsum on one side of the wrist joint, and the forearm support part 120 worn on the trainee's forearm on the other side of the wrist joint so that wearing comfort is enhanced and more stable support is provided. Since the trainee's wrist joint allows the hand to rotate in two directions, which are the flexion-extension direction and the radioulnar direction, the hand dorsum support part 110 and the forearm support part 120 must be rotatably connected in both directions to enable various exercises for the hand.

Here, the hand dorsum support part 110 and the connection support part 130 may be rotatably connected to each other in the flexion-extension direction, while the forearm support part 120 and the connection support part 130 may be rotatably connected to each other in the radioulnar direction. Alternatively, the hand dorsum support part 110 and the connection support part 130 may be rotatably connected to each other in the radioulnar direction, while the forearm support part 120 and the connection support part 130 may be rotatably connected to each other in the flexion-extension direction. Since the hand dorsum support part 110 is adjacent to the finger joint performing the extension motion, it may be preferable, in terms of hand joint motion dynamics, for the hand dorsum support part 110 to be rotatably connected to the connection support part 130 in the flexion-extension direction. For this purpose, the hand dorsum support part 110 and the connection support part 130 may be rotatably connected to each other in the flexion-extension direction via a first rotation axis 140, and the forearm support part 120 and the connection support part 130 may be rotatably connected to each other in the radioulnar direction via a second rotation axis 160.

The connection support part 130 may include a motion-limiting part 170 that limits a flexion-extension angle or radioulnar angle. For example, the motion-limiting part may be a stopper (not shown), such as a protrusion, which limits a range of rotation in the flexion-extension direction by making contact between the hand dorsum support part 110 and the connection support part 130 within a safe wrist movement angle range of the trainee at maximum extension and maximum flexion. Alternatively, the motion-limiting part 170 may restrict the radial and ulnar movements of the wrist joint to a safe range between the forearm support part 120 and the connection support part 130. The motion-limiting part 170 may fix the relative position of the hand dorsum support part 110 and the connection support part 130 to allow only radioulnar motion of the wrist joint, and alternatively, the motion-limiting part 170 may fix the relative position of the forearm support part 120 and the connection support part 130 to allow only extension motion of the wrist joint.

The wrist support part 100 may further include a wire guide part 150, fixed to at least one of the hand dorsum support part 110 or the connection support part 130, to guide the movement of the wires 300.

In the exercise device for hand rehabilitation according to the embodiment of the present inventive concept, since the extension motion and radioulnar motion of the hand joints are trained by the movements of the plurality of wires 300 connected to each of the plurality of fingers, it is necessary to prevent the plurality of wires 300 from tangling or deviating during hand exercise for hand, and the relative movement positions and angles of the wires corresponding to each finger must remain consistent. The wire guide part 150 may be provided on the hand dorsum support part 110 or the connection support part 130, where the wires 300 pass through, to guide the movement of the wires 300, thereby preventing the wires 300 from tangling or deviating and ensuring that the movement positions and angles of the wires 300 remain consistent. The wire guide part 150 may include a concave portion or a through-hole into which the wire 300 is movably accommodated and may also provide a pulley therein to facilitate smooth movement.

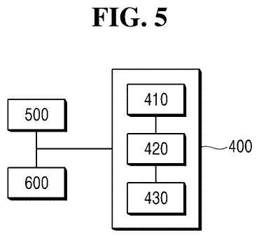

FIG. 5 is a view illustrating a configuration of the driving part of the exercise device for hand rehabilitation according to an embodiment of the present inventive concept.

Referring to FIG. 5, the exercise device for hand rehabilitation according to an embodiment of the present inventive concept may further include a wire connection part 310 to which the plurality of wires 300 are connected. The driving part 400 may include a motor part 410 for moving the wire connection part 310 and a control part 420 for providing a driving signal to the motor part 410.

To individually drive the plurality of wires 300 connected to the plurality of fingers of the trainee, a plurality of motor parts or a complex transmission mechanism, which provides individual driving force to each wire would typically be required. Since the exercise device for hand rehabilitation is worn by the hand trainee, if the device includes the plurality of motor parts or the complex transmission mechanism, it may increase the weight and size of the device, making it difficult for the trainee to wear during hand exercise. Accordingly, in the present inventive concept, after the plurality of wires 300 are connected to the wire connection part 310, and the wire connection part 310 may be moved by the motor part 410, enabling the movement of the plurality of wires with a simple structure. When the motor part 410 moves the wire connection part 310 to simultaneously move the plurality of wires 300, there may be limitations in training the plurality of fingers having different lengths and ranges of motion. To address this, in the present inventive concept, the length of the wires may be adjusted using the wire length adjustment parts 240 to match the lengths of individual fingers, or elastic wires may be used to compensate for the differences in finger lengths and ranges of motion among the plurality of fingers.

The control part 420 may provide the driving signal to the motor part 410 to control various aspects of the wire's movement, including speed, acceleration, position, direction, range, start time, and end time.

The control part 420 may operate the motor part 410 based on exercise execution information to control the movement and position of the wire connection part 310 and/or the wires 300 in various ways. Here, the exercise execution information may include at least one of the movement speed, the movement acceleration, the movement position, the movement direction, or the movement range of the wires.

The exercise device for hand rehabilitation according to an embodiment of the present inventive concept may further include a sensor part 500 for measuring an electrical signal generated in nerves or muscles of the trainee's wrist. The control part 420 may generate the driving signal based on a measurement signal from the sensor part 500. Here, the sensor part 500 may be an EMG (electromyography) detection sensor, but it is not limited thereto.

An extensor muscle, which extends the hand and finger, covers a rear surface of the forearm, while a flexor muscle, which flex the hand and finger, stabilizes the wrist during hand movements. When the hand trainee attempts to move his hand and finger, changes in the extensor and/or flexor muscles, or the nerves surrounding these muscles, may occur before visible movement of the hand and finger.

The EMG (electromyography) signal, one of the electrical signals generated in the nerves or muscles of the trainee's wrist, is produced along the muscle fibers on a muscle surface in response to the movements of the body (e.g., hand and fingers). Since differences in the intensity of the measured signal correspond to the strength of the muscle force causing bodily movement, the presence or absence of the measured signal, as well as its intensity differences, may be used to detect the user's intent to move even before actual body movement is observed.

In other words, when the sensor part 500 is disposed on a skin surface of the wrist extensor and/or flexor muscles, and the trainee intends extension movements of the hand and the differences in muscle strength, different electrical signals are generated according to the movements or muscle strength of the forearm extensor or flexor muscles, and the sensor part 500 may measure the electrical signal or their variations according to capture the trainee's intent to exercise. The measurement signal detected by the sensor part 500 may be transmitted to the control part 420, and the control part 420 may generate the driving signal using preset exercise execution information based on the measurement signals and controls the motor part 410 accordingly. Therefore, the exercise device for hand rehabilitation according to an embodiment of the present inventive concept may provide various exercising modes that allow control of hand joint motion trajectories, motion intensity, and motion speed, reflecting the trainee's intent to train.

The exercise device for hand rehabilitation according to an embodiment of the present inventive concept may further include a exercise condition setting part 600 for setting at least one hand exercise condition among a motion trajectory, a motion speed, a motion acceleration, a motion position, a motion direction, a motion range, a motion angle, a motion intensity, or the trainee's exercising pattern. The control part 420 may generate the driving signal according to the exercise condition set by the exercise condition setting part. Here, the control part 420 may modify the driving signal generated based on the exercise condition set by the exercise condition setting part 600, referencing the electrical signal generated in the nerves or muscles of the trainee's wrist measured by the sensor part 500, and then the modified driving signal may be provided control the motor part 410 to control the motor part 410.

Meanwhile, the sensor part 500 and the exercise condition setting part 600 may be mounted on the driving part 400 or provided as a separate device connected to the driving part 400 in a wired or wireless manner.

The driving part 400 may further include an input/output part (not shown) that receives selections for exercise execution information from the trainee or others, or outputs exercise execution information in a way that the trainee or others may recognize it. As one example of the input/output part, a touchscreen may be provided to allow the trainee to input selections by viewing information displayed on a screen and touching it. To enable the trainee to understand the contents of the exercise execution information, the driving part 400 may deliver the exercise execution information to the touchscreen for display.

Additionally, to enable customized hand exercise for the trainee, the exercise execution information may include details about the trainee's past hand exercising history and information on the trainee's hand exercising limitations to avoid excessive strain. The hand exercising limitation may include, for example, the maximum allowable movement speed or force of the wires 300.

The trainee may reset or modify the exercise execution information by referencing the exercise execution information. That is, the trainee may input changes or reset requests by touching the exercise execution information displayed on the touchscreen. The control part 420, which receives the modified or reset exercise execution information from the trainee, may drive the motor part 410 according to the modified or reset exercise execution information, thereby controlling the movement and position of the wires 300 and facilitating the trainee's hand exercise.

The driving part 400 may further include a detachable battery part to supply power to the motor part 410 and the control part 420, allowing the trainee to wear the exercise device for hand rehabilitation and perform hand exercise freely.

According to the exercise device for hand rehabilitation of an embodiment of the present inventive concept, by pulling or releasing the plurality of wires, each connected to the plurality of finger-wearing parts, the exercise device for hand rehabilitation may assist the movement of the trainee's hand joints without requiring additional joint parts or connection structures corresponding to the hand joints. This enables the provision of various and natural motion trajectories that align with the motion of the hand joints, allowing the trainee to safely and comfortably perform hand joint rehabilitation exercise without experiencing discomfort.

Also, the position of the finger fixation pads worn on the distal segments of the trainee's fingers may be adjusted to enable the trainee to wear the exercise device for hand rehabilitation and perform hand exercise regardless of the length of their fingers. Accordingly, the lengths of the wires respectively connected to the plurality of finger-wearing parts may be adjusted, sequential extension motion of the distal interphalangeal joints, the proximal interphalangeal joints, and the metacarpophalangeal joints of the index, middle, ring, and little fingers, as well as the interphalangeal joint, metacarpophalangeal joint of the thumb, among the five fingers, and the wrist joint, may be provided to all hand trainees. Furthermore, it is possible to enable sequential extension motion of individual finger joints while simultaneously moving the wires toward the distal segments of the trainee's fingers.

In addition, the hand dorsum support part may be rotatably connected in the flexion-extension direction, and the forearm support part may be rotatably connected to the connection support part in the radioulnar direction, allowing the hand trainee to perform not only extension motion of the hand joints but also radioulnar motion of the hand joints, enabling more effective hand rehabilitation exercise.

Additionally, since the hand exercise is performed based on electrical signals generated in the nerves or muscles of the trainee's wrist or according to preset hand exercise conditions, discomfort experienced by the hand trainee may be alleviated, and the scope of hand exercise without feeling discomfort may be expanded.

Furthermore, it may provide a sufficient and safe range of motion trajectories without requiring a structure for the hand part that includes multiple joints, as seen in conventional hand exercise devices, thereby reducing the structural complexity of the exercise device for hand rehabilitation. As the complexity of the structure is improved, the manufacturing productivity of the exercise device for hand rehabilitation may also be enhanced, while manufacturing costs may be reduced at the same time.

The term “˜ on” used in the above description includes direct contact and indirect contact at a position that is opposite to an upper and lower portion. It is also possible to locate not only the entire top surface or the entire bottom surface but also the partial top surface or the bottom surface, and it is used in the mean that it is opposed in position or contact directly to upper or bottom surface. Also, the terms such as ‘above’, ‘below’, ‘front end’, ‘rear end’, ‘upper’, ‘lower’, ‘top’, ‘bottom’ used in the above description are defined based on the drawings for convenience, and the shape and position of each component are not limited by these terms.

Although the exemplary embodiments have been described, the present disclosure is not limited thereto. Therefore, it will be understood by those skilled in the art to which the present disclosure pertains that various modifications and equivalent other embodiments are possible therefrom without departing from the subject matter of the present disclosure as set forth in the claims. Hence, the technical protective scope of the present disclosure should be determined by the appended claims.

1. An exercise device for hand rehabilitation, the exercise device comprising:
a wrist support part worn on a wrist of a trainee;
a plurality of finger-wearing parts worn on fingers of the trainee;
a plurality of wires respectively connected to the plurality of finger-wearing parts; and
a driving part configured to provide driving force by pulling or releasing the plurality of wires to move the plurality of finger-wearing parts.

2. The exercise device of claim 1, wherein the driving part is fixed to the wrist support part.

3. The exercise device of claim 1, wherein each of the plurality of finger-wearing parts comprises:
a finger fixation pad worn on a distal segment of the trainee's finger;
a connection member to which the finger fixation pad is connected and fixed; and
a wire path guide fixed to the connection member to guide a movement path of the wire.

4. The exercise device of claim 3, wherein the wire path guide comprises:
a first wire path guide, which is fixed to the connection member to extend outward from the connection member and is configured to guide the movement path of the wire, and
a second wire path guide, which is spaced apart from the first wire path guide and fixed to the connection member to extend outward and is configured to guide the movement path of the wire.

5. The exercise device of claim 4, wherein the first wire path guide has a length extending outward longer than that of the second wire path guide.

6. The exercise device of claim 4, wherein the connection member has a shape extending in one direction,
the first wire guide is fixed to one end of the connection member corresponding to a position to which the finger fixation pad is connected, and
the second wire path guide is fixed to the other end of the connection member spaced apart in one direction from the one end of the connection member.

7. The exercise device of claim 4, wherein the connection member comprises a wire fixation part to which wires, which are respectively connected to the plurality of finger-wearing parts, are fixed, and
the wire fixation part is provided between a position at which the first wire path guide is fixed to the connection member and a position at which the second wire path guide is fixed to the connection member.

8. The exercise device of claim 3, wherein each of the plurality of finger-wearing parts further comprises a wire length adjustment part configured to adjust a length of the wire according to a length of the trainee's finger.

9. The exercise device of claim 1, wherein the plurality of wires are made of an elastic material.

10. The exercise device of claim 1, wherein the wrist support part comprises:
a hand dorsum support part worn on a trainee's hand dorsum;
a forearm support part worn on a trainee's forearm; and
a connection support part to which the hand dorsum support part and the forearm support part are rotatably connected.

11. The exercise device of claim 10, wherein the hand dorsum support part and the connection support part are rotatably connected to each other in a flexion-extension direction, and
the forearm support part and the connection support part are rotatably connected to each other in a radioulnar direction.

12. The exercise device of claim 11, wherein the connection support part comprises a motion-limiting part configured to limit a flexion-extension angle or a radioulnar angle.

13. The exercise device of claim 10, wherein the wrist support part further comprises a wire guide part fixed to at least one of the hand dorsum support part or the connection support part to guide the movement of the wires.

14. The exercise device of claim 1, further comprising a wire connection part to which the plurality of wires are connected,
wherein the driving part comprises:
a motor part configured to move the wire connection part; and
a control part configured to provide a driving signal to the motor part.

15. The exercise device of claim 14, further comprising a senor configured to measure an electrical signal generated in nerves or muscles of the trainee's wrist, wherein the control part generates the driving signal based on a measurement signal from the sensor part.

16. The exercise device of claim 14, further comprising an exercise condition setting part configured to set at least one hand exercise condition among a motion trajectory, a motion speed, a motion acceleration, a motion position, a motion direction, a motion range, a motion angle, a motion intensity, or the trainee's exercising pattern,
wherein the control part generates the driving signal according to the exercise condition set by the exercise condition setting part.
